(19) United States
(12) Patent Application Publication
(10) Pub. No.: US 2021/0323249 A1
(43) Pub. Date: Oct. 21, 2021

(54) TOOLING SET AND METHOD FOR PRODUCING A COMPOSITE PART

(71) Applicant: The Boeing Company, Chicago, IL (US)

(72) Inventor: James R. Kendall, Mt. Pleasant, SC (US)

(73) Assignee: The Boeing Company, Chicago, IL (US)

(21) Appl. No.: 16/849,178

(22) Filed: Apr. 15, 2020

(51) Int. Cl. B29C 70/44; B29C 70/54

(52) U.S. Cl. CPC B29C 70/443; B29K 2307/04; B29C 70/54

(57) ABSTRACT

A method of producing a composite part using first and second mandrels is presented, wherein each of the mandrels has a respective side, a respective generally planar tool surface for forming a respective portion of the composite part thereon and a respective chamfer between the respective side and the respective tool surface. The method includes disposing the first and second mandrels with their respective sides abutted with each other such that the tool surfaces are flush with each other and define a generally planar combined surface and the chamfers define a trough, placing an elastomeric plug in the trough, wherein the elastomeric plug substantially fills the trough, and applying a layer of composite material across the generally planar combined surface and across a top surface of the elastomeric plug so as to form the composite part. A tooling set for producing a composite part using the method is also presented.

### INTRODUCTION

This disclosure relates generally to tooling sets and methods for producing composite parts.

Aircraft fuselages and other structural parts are commonly made of composite materials such as carbon fiber fabric infused with a resin (so-called “prepreg” sheets), and may be produced by processes such as vacuum bagging. In the vacuum bagging process, sheets of carbon fiber prepreg are laid across the tool surfaces of a vacuum bagging tool, which may comprise a plurality of mandrels. For example, mandrels for an aircraft fuselage may be arranged in a generalized “barrel” shape with the tool surfaces of the mandrels facing outward from the barrel. In addition to the layers of carbon fiber prepreg laid onto the barrel-shaped arrangement of tool surfaces, various layers of release films, peel plies, breathers, bleeders, cauls and bagging film are also included, and a vacuum is applied to draw the air out of the space between the bagging film and the tool surfaces to facilitate the curing process.

When adjacent mandrels are brough together to form the aforementioned barrel-shaped arrangement, there may be mismatches or misalignments between the tool surfaces (and/or other surfaces or features) of adjacent mandrels. These mismatches or misalignments may be addressed by the use of shims or other measures, but addressing such mismatches or misalignments requires time and resources. Also, the presence of such mismatches or misalignments may cause quality or assembly issues, even if currently known measures are used to address the mismatches or misalignments.

### SUMMARY

According to one embodiment, a method of producing a composite part using first and second mandrels is presented. Each of the mandrels has a respective side, a respective generally planar tool surface for forming a respective portion of the composite part thereon and a respective chamfer between the respective side and the respective tool surface. The method includes the steps of: disposing the first and second mandrels with their respective sides abutted with each other such that the tool surfaces are flush with each other and define a generally planar combined surface and the chamfers define a trough; placing an elastomeric plug in the trough, wherein the elastomeric plug substantially fills the trough; and applying a layer of composite material across the generally planar combined surface and across a top surface of the elastomeric plug so as to form the composite part.

The method may further include removing the elastomeric plug from the trough. The elastomeric plug may be an inflatable bladder, and the method may further include deflating the elastomeric plug. The top surface of the elastomeric plug may be disposed outward from the generally planar combined surface, and the method may further include draping a first release layer across a portion of the respective generally planar tool surface and a portion of the respective chamfer of the first mandrel. Alternatively, the top surface of the elastomeric plug may be disposed substantially flush with the generally planar combined surface, and the method may further include adding a second release layer across the generally planar combined surface and the top surface of the elastomeric plug. The method may further include curing the composite part by applying at least one of heat, electromagnetic radiation, pressure and vacuum. The generally planar combined surface may be a flat surface or a curved surface, and an interference fit may be provided between the elastomeric plug and the sides of the first and second mandrels.

According to another embodiment, a method of producing a composite part using first and second mandrels is presented. Each of the mandrels has a respective side, a respective generally planar tool surface for forming a respective portion of the composite part thereon and a respective chamfer between the respective side and the respective tool surface. The method includes the steps of: (i) disposing the first and second mandrels with their respective sides abutted with each other such that the tool surfaces are flush with each other and define a generally planar combined surface and the chamfers define a trough; (ii) placing an elastomeric plug in the trough, wherein the elastomeric plug substantially fills the trough; (iii) applying a layer of composite material across the generally planar combined surface and across a top surface of the elastomeric plug so as to form the composite part; (iv) removing the elastomeric plug from the trough; and (v) curing the composite part by applying at least one of heat, electromagnetic radiation, pressure and vacuum. The elastomeric plug may be an inflatable bladder, and the method may further include deflating the elastomeric plug.

According to yet another embodiment, a tooling set for producing a composite part includes first and second mandrels, wherein each of the mandrels has a respective side, a respective generally planar tool surface for forming a respective portion of the composite part thereon and a respective chamfer between the respective side and the respective tool surface. The mandrels are configured such that when the mandrels are disposed with their respective sides abutted with each other the tool surfaces are disposed flush with each other and define a generally planar combined surface and the chamfers define a trough. The tooling set also includes an elastomeric plug configured for insertion into the trough, thereby defining a plugged arrangement, wherein the elastomeric plug substantially fills the trough.

The elastomeric plug may be an inflatable bladder, and the elastomeric plug may be shaped as an extrusion having a cross-sectional profile substantially similar to a cross-sectional shape of the trough. Each chamfer may have a respective profile shaped as a straight chamfer profile, a cove profile or an ogee profile, and the generally planar combined surface may be a flat surface or a curved surface. A top surface of the elastomeric plug may generally conform in shape with the generally planar combined surface. In the plugged arrangement, the top surface of the elastomeric plug may be disposed substantially flush with or generally outward from the generally planar combined surface, and an interference fit may be provided between the elastomeric plug and the sides of the first and second mandrels.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic cross-sectional view of a tooling set for producing a composite part in accordance with the present disclosure.

FIG. 2 is a flowchart for a method of producing a composite part in accordance with the disclosure.

FIG. 3 is a schematic cross-sectional exploded side view of a tooling set with first mandrel, second mandrel and elastomeric plug separated from each other.

FIG. 4 is a schematic cross-sectional assembled side view of the tooling set of FIG. 3 with the first and second mandrels and elastomeric plug in a plugged arrangement, with the top of the elastomeric plug disposed flush with the tool surfaces.

FIG. 5 is a schematic cross-sectional assembled side view of an alternative configuration of the tooling set with the first and second mandrels and elastomeric plug in a plugged arrangement, with the top of the elastomeric plug disposed outward from the tool surfaces.

FIG. 6 is a schematic cross-sectional assembled view of the alternative configuration shown in FIG. 5, after applying a layer of composite material thereon and before the draping of a release layer across the elastomeric plug and the composite material.

FIG. 7 shows a schematic cross-sectional partially assembled view of a tooling set in which the elastomeric plug is configured for an interference fit with a trough formed between abutted first and second mandrels.

FIG. 8 shows a schematic cross-sectional assembled side view of the tooling set of FIG. 4 after applying a layer of composite material thereon.

FIG. 9 shows a schematic cross-sectional assembled side view of the tooling set of FIG. 6 with a thicker layer of composite material applied so as to cover the elastomeric plug.

FIGS. 10A-C show schematic cross-sectional views of exemplary straight chamfer, cove and ogee profiles, respectively, for the first and second chamfers.

### DETAILED DESCRIPTION

Referring now to the drawings, wherein like numerals indicate like parts in the several views, a method 100 of producing a composite part 22, and a tooling set 20 for use with the method 100, are shown and described herein.

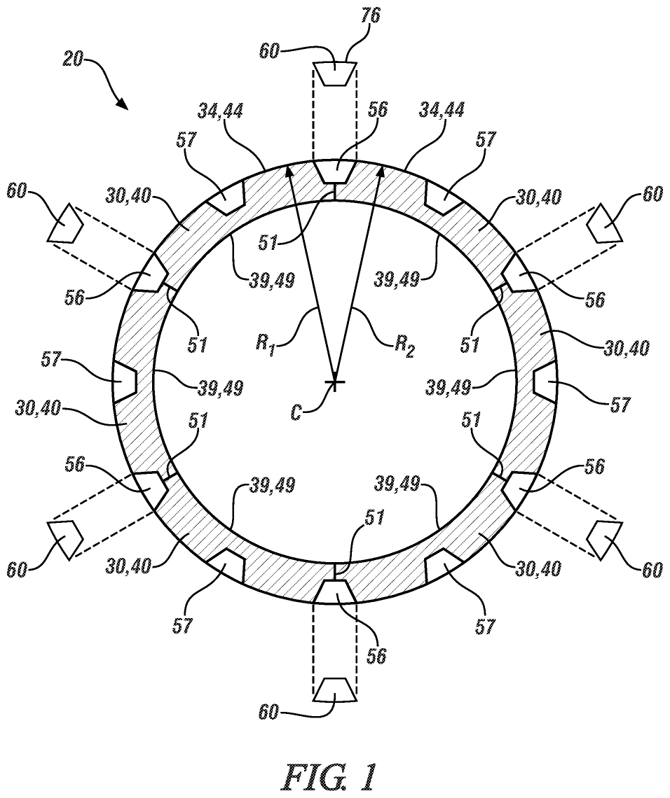

FIG. 1 shows a schematic cross-sectional view of a tooling set 20 for producing a composite part 22 in accordance with the present disclosure. (Note that the composite part 22 is not shown in FIG. 1, but is shown in FIG. 6.) The tooling set 20 is illustrated here in cross-section as an annulus or ring made of six identical mandrels 30, 40 with each mandrel 30, 40 spanning one-sixth of the circumference of the annulus. In the arrangement shown here where all the mandrels 30, 40 are identical with each other, each mandrel may be considered a first mandrel 30 having an adjacent second mandrel 40 on either side circumferentially; similarly, each mandrel may also be considered a second mandrel 40 having an adjacent first mandrel 30 on either side circumferentially. The annular arrangement of mandrels 30, 40 shown in FIG. 1 may be viewed as forming a “barrel” in three-dimensional space, with the barrel extending for some length into and out of the plane of the cross-section. This barrel-shaped tooling set 20 comprised of mandrels 30, 40 may be used to form the aforementioned composite part 22, which may be a fuselage of an aircraft. Note, however, that in other configurations of the tooling set 20, the mandrels 30, 40 may be different from each other and/or there may be only two mandrels 30, 40 disposed beside each other rather than comprising an annulus of six mandrels 30, 40.

In the annular configuration of the tooling set 20 shown in FIG. 1, the first and second mandrels 30, 40 have respective first and second “top” tool surfaces 34, 44 defined on the outer circumferential surface of the annulus, and respective first and second “bottom” surfaces 39, 49 defined on the inner circumferential surface of the annulus. The outer circumferential surface defines a circle having a center C, with a first radius R₁ extending from the center C to each first tool surface 34 and a second radius R₂ extending from the center C to each second tool surface 44. Because the outer circumferential surface is circular, first radius R₁ and second radius R₂ are equal to each other. Each adjacent pair of first and second mandrels 30, 40 is abutted together so as to form a seam 51 therebetween at the point of abutment. The tooling set 20 further includes a plurality of troughs or channels 56, 57 defined in the first and second tool surfaces 34, 44 (i.e., in the outer circumferential surface of the annulus), with a first set of troughs 56 being defined radially outward from respective seams 51 where the mandrels 30, 40 meet, and with a second set of troughs 57 being defined circumferentially between individual troughs 56 of the first set. FIG. 1 shows a total of twelve troughs 56, 57 for illustration purposes, but the tooling set 20 may provide more or less than twelve troughs 56, 57. Also, all of the troughs 56, 57 shown here appear to be of the same shape and size, but some configurations of tooling sets 20 may include troughs 56, 57 of various shapes and sizes. Composite material 28 (not shown in FIG. 1, but shown in FIGS. 6, 8 and 9) may be placed across the entirety of the first and second tool surfaces 34, 44 (i.e., across the entire outer circumferential surface), including within the troughs 56, 57, so as to form stringers in the troughs 56, 57 and first and second portions 24, 26 of the composite part 22, in which the first and second portions 24, 26 and the stringers are intercontiguated or connected in a continuous fashion about the outer circumference of the tooling set 20, so as to form one continuous composite part 22 (e.g., a portion of an aircraft fuselage).

Optionally, as further described in more detail below, an elastomeric plug 60 may be inserted into each one of the first set of troughs 56 before the composite material 28 is applied, thereby forming stringers only within each of the second set of troughs 57. Thus, each of the first set of troughs 56 may be formed where adjacent first and second mandrels 30, 40 abut each other at each seam 51. In such an arrangement, the size and shape of each one of the first set of troughs 56 adjacent an abutment seam 51 may be different from each one of the second set of troughs 57 a stringer is formed. For example, the troughs 56 of the first set may be much smaller than the troughs 57 of the second set. While the second set of troughs 57 may be used to form stringers, the first set of troughs 56 may be used to obviate or reduce cosmetic or joinder issues where adjacent mandrels 30, 40 meet.

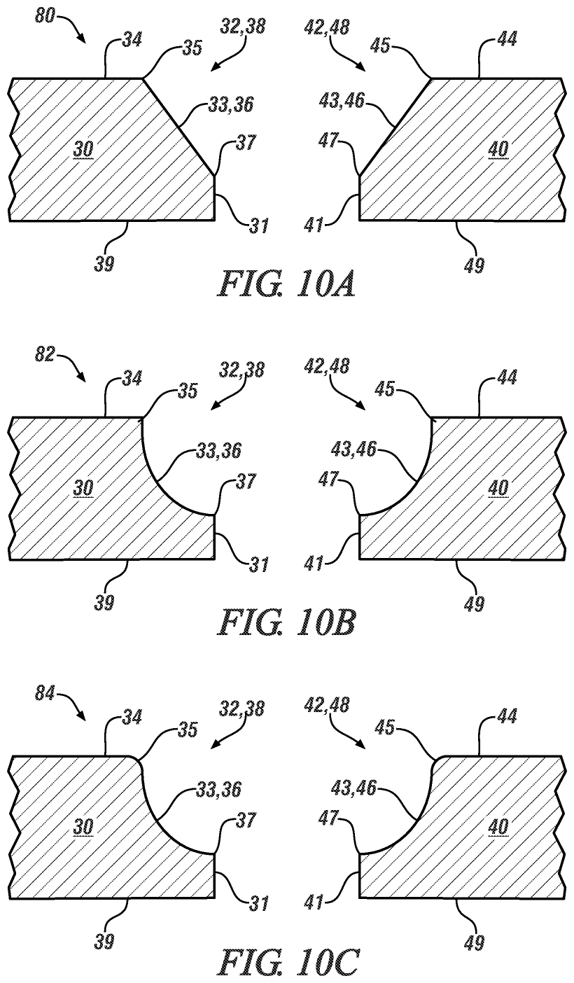

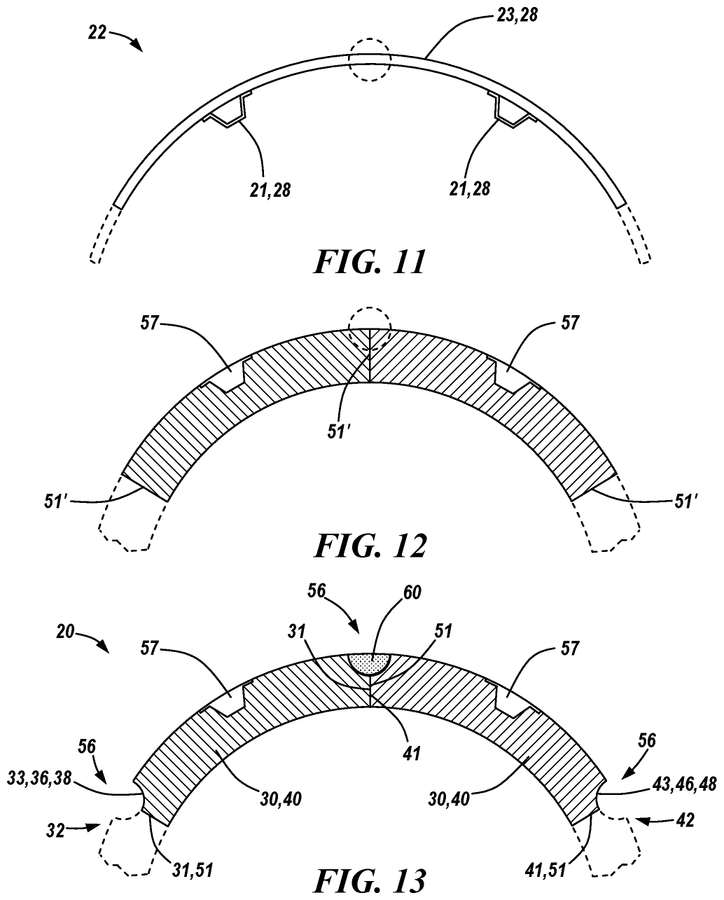

Note that while the abutment between adjacent first and second mandrels 30, 40 is illustrated and described herein as a seam 51, such contact or abutment between adjacent mandrels 30, 40 may take the form of one or more contact points, one or more contact surfaces, etc., and may include the interlocking of respective features between abutted mandrels 30, 40. Also, while the annular arrangement illustrated in cross-section in FIG. 1 shows the first and second tool surfaces 34, 34 to be curved, thereby defining a curved plane in three-dimensional space, the tool surfaces 34, 44 may also assume other shapes, such as defining a flat plane in three-dimensional space (as illustrated in FIGS. 7 and 10A-C).

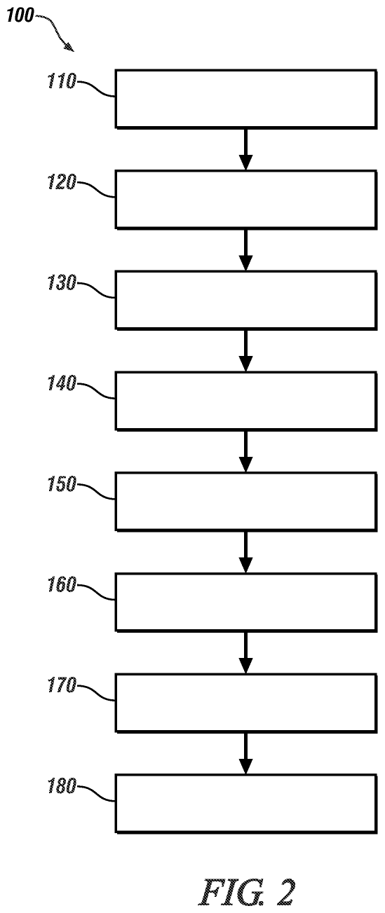

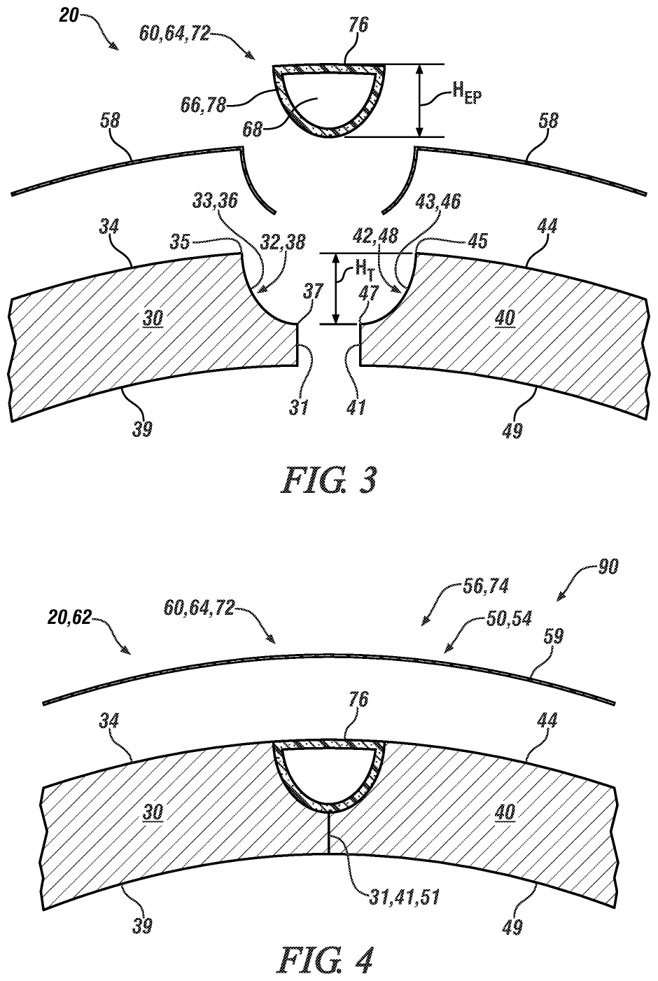

FIG. 2 shows a flowchart for a method 100 of producing the composite part 22 using a tooling set 20 having first and second mandrels 30, 40, and FIGS. 3-9 show various configurations and arrangements of a tooling set 20 suitable for use with the method 100. FIG. 3 shows a schematic cross-sectional exploded side view of the tooling set 20, which includes first and second mandrels 30, 40 and an elastomeric plug 60. The first mandrel 30 has a first side 32, a generally planar first tool surface 34 for forming a first portion 24 of the composite part 22 thereon, and a first chamfer 36 situated between the first side 32 and the first tool surface 34. Similarly, the second mandrel 40 has a second side 42, a generally planar second tool surface 44 for forming a second portion 26 of the composite part 22 thereon, and a second chamfer 46 situated between the second side 42 and the second tool surface 44. The first side 32 includes the first chamfer 36 (defining a first shaped portion 33) and a first abuttable portion 31, while the second side 42 includes the second chamfer 46 (defining a second shaped portion 43) and a second abuttable portion 41, wherein the first and second abuttable portions 31, 41 may form a seam 51 when the mandrels 30, 40 are abutted with each other. A first top corner 35 is defined where the first chamfer 36 meets the first tool surface 34, and a first bottom corner 37 is defined where the first chamfer 36 meets the first abuttable portion 31; similarly, a second top corner 45 is defined where the second chamfer 46 meets the second tool surface 44, and a second bottom corner 47 is defined where the second chamfer 46 meets the second abuttable portion 41. The first and second chamfers 36, 46 may be mirror images of each other, and may assume various cross-sectional profiles 38, 48 as discussed in further detail below.

Turning again to the method 100 of FIG. 2, and with further reference to FIG. 4, at block 110 the first and second mandrels 30, 40 are brought together and disposed with their respective first and second sides 32, 42 abutted with each other (e.g., first and second abuttable portions 31, 41 are abutted together), such that the first and second tool surfaces 34, 44 are disposed flush with each other and define a generally planar combined surface 50, and the first and second chamfers 36, 46 define a trough 56. Here, “flush” means that the tool surfaces 34, 44 are at the same height as viewed in cross-section; for example, as illustrated in FIG. 1, a first tool surface 34 may be disposed at a first radius R₁ from a center of curvature C of the tooling set 20, and an adjacent second tool surface 44 may be disposed at a second radius R₂ from the center of curvature C which is the same as the first radius R₁. With both adjacent tool surfaces 34, 44 disposed thusly, the tool surfaces 34, 44 define a generally planar combined surface 50 having a radius of curvature which is the same as the first and second radii R₁, R₂. If both tool surfaces 34, 44 are curved (as illustrated in FIGS. 1, 3-6 and 8-9), then the generally planar combined surface 50 will likewise be a curved surface 54, but if the tool surfaces 34, 44 are flat (as illustrated in FIGS. 7 and 10A-C), then the generally planar combined surface 50 will likewise be a flat surface 52. In either case, the mandrels 30, 40 and tooling set 20 may be considered as being in an abutted arrangement, as illustrated in FIGS. 4-9.

At block 120, the method 100 may further include an optional step of draping a first release layer 58 across a portion of the first tool surface 34 and a portion of the first chamfer 36. This optional step may further include draping another first release layer 58 across a portion of the second tool surface 44 and a portion of the second chamfer 46 of the second mandrel 40. These first release layers 58 may be seen in FIG. 3, where they are shown as conforming in shape or profile with their respective first and second tool surfaces 34, 44 and their respective first and second chamfers 36, 46. The first release layer 58 may extend along only a portion of each side 32, 42 of the chamfers 36, 46 or trough 56, or it may extend along the entirety of each side 32, 42, thus covering essentially the entirety of the surface of the trough 56. The first release layer 58 may be a thin sheet of flexible plastic material suitable for use as a separator and/or release sheet between the tool surfaces 34, 44 and chamfers 36, 46 on the one hand, and composite materials 28 (including resins) on the other hand. As illustrated in FIG. 3, two separate sheets of first release layer 58 may be used, with each sheet of first release layer 58 draping one side 32 or the other 42 of the trough 56; alternatively, a single sheet of first release layer 58 may be draped across both tool surfaces 34, 44 and across the entirety of the trough 56.

At block 130, and as shown in FIG. 4, an elastomeric plug 60 is placed in the trough 56, with the elastomeric plug 60 substantially filling the trough 56, thereby defining a plugged arrangement 62. As illustrated in FIGS. 3-6 and 8-9, the elastomeric plug 60 may take the form of an inflatable bladder 64 having thin walls 66 defining an interior 68 which may be filled and inflated with air or other fluid; alternatively, as illustrated in FIG. 7, the elastomeric plug 60 may be solid. In either case, the elastomeric plug 60 may be made of rubber, silicone or other elastomeric material (including fluoroelastomers such as VITON™ produced by The Chemours Company). The elastomeric material may include fiberglass or other reinforcement material concentrated in particular portions of the plug 60 (such as on the interior surface of the walls 66 of an inflatable bladder 64) or dispersed throughout the elastomeric material. Additionally, the plug 60 may have temporary or permanent coatings on its exterior top and side surfaces 76, 78, such as TEFLON™ (produced by The Chemours Company) or release agents. The plug 60 may also be made of two or more layers of elastomeric materials.

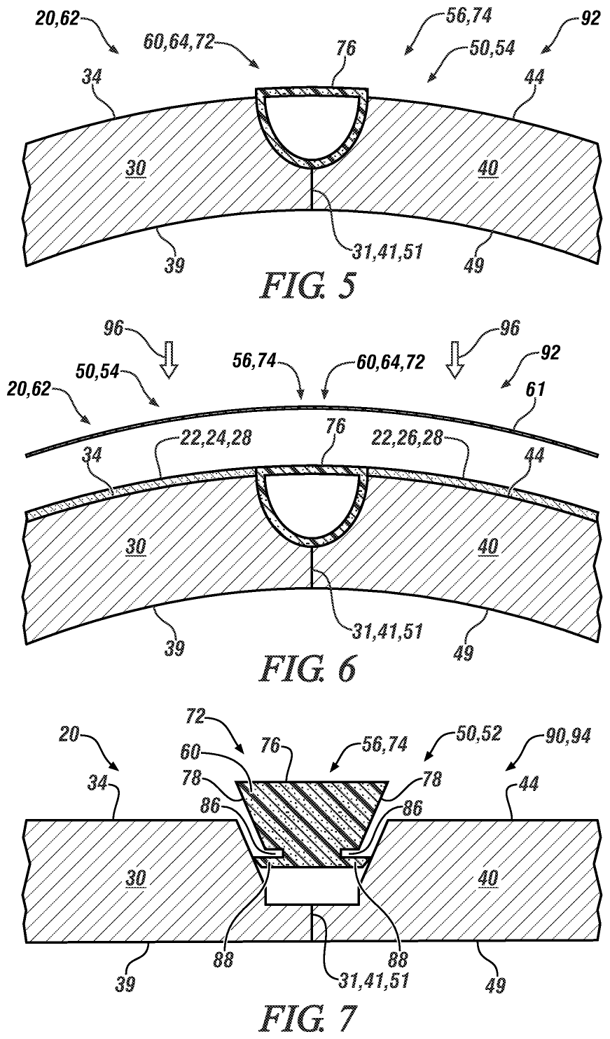

The elastomeric plug 60 is sized and shaped to have a cross-sectional profile 72 which conforms with the size, shape and cross-sectional profile 74 of the trough 56. The elastomeric plug 60 has opposed side surfaces 78 which generally conform with the respective shaped portions 33, 43 and profiles 38, 48 of the chamfers 36, 46. The elastomeric plug 60 also has a top surface 76 which may be substantially flush with the first and second tool surfaces 34, 44 (and thus substantially flush with the generally planar combined surface 50 as well), as illustrated in FIGS. 3-4 where the height H_{EP} of the elastomeric plug 60 is substantially the same as the height H_{T} of the trough 56, thus providing a flush arrangement 90; or, the top surface 76 may extend outward from the generally planar combined surface 50, as illustrated in FIGS. 5-6 where the height H_{EP} of the elastomeric plug 60 is larger than the height H_{T} of the trough 56, thus providing a protruding arrangement 92. The elastomeric plug 60 may be designed for pressure expansion and/or thermal expansion to achieve a desired application of pressure against the composite material 28 used to produce the composite part 22, in order to protect and control the resin content between the plug 60 on one hand and the caul or other adjacent layers on the other hand.

At block 140, and as illustrated in FIG. 4, the method 100 may further include an optional step of adding a second release layer 59 across the generally planar combined surface 50 and the top surface 76 of the elastomeric plug 60. This optional step may be particularly well suited for cases where the top surface 76 is disposed substantially flush with the generally planar combined surface 50. The second release layer 59 may be a thin sheet of flexible plastic material suitable for use as a separator and/or release sheet similar to the first release layer 58, and it may be utilized in addition to or instead of the first release layer 58.

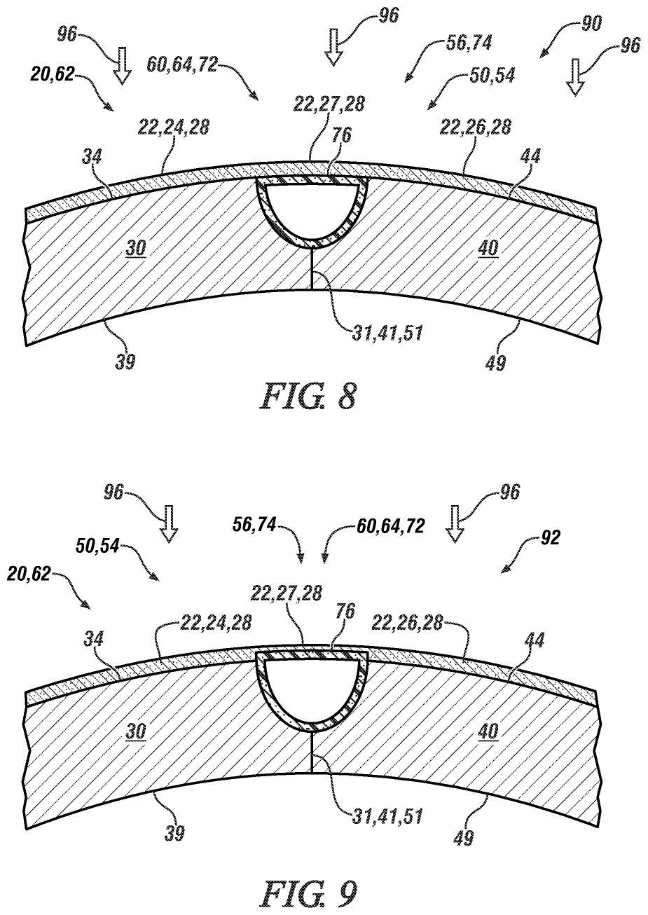

At block 150, and as illustrated in FIGS. 6, 8 and 9, a layer of composite material 28 may be applied across the generally planar combined surface 50, and optionally across the top surface 76 of the elastomeric plug 60 as well, so as to form the composite part 22. In FIG. 6, the composite material 28 is applied across the generally planar combined surface 50 (i.e., across the first and second tool surfaces 34, 44), while in FIGS. 8-9 the composite material 28 is applied across the generally planar combined surface 50 (i.e., across the first and second tool surfaces 34, 44) as well across the top 76 of the elastomeric plug 60. A first portion 24 of the composite part 22 is formed by the composite material 28 covering the first tool surface 34, and a second portion 26 of the composite part 22 is formed by the composite material 28 covering the second tool surface 44. A third portion 27 of the composite part 22 is formed by the composite material 28 covering the top 76 of the elastomeric plug 60. The first, second and third portions 24, 26, 27 may be formed such that adjacent portions 24, 26, 27 are not only contiguous with each other, but also continuous with each other, in the sense that the composite material 28 may be applied across all three portions 24, 26, 27 (and thus across the first and second tool surfaces 34, 44 and the top 76 of the elastomeric plug 60) in one or more continuous passes (e.g., one or more applications of carbon fiber prepreg layers, with each layer spanning all three portions 24, 26, 27).

Note that the optional step 140 of adding a release layer across the generally planar combined surface 50 and the top surface 76 of the elastomeric plug 60 may also be performed after step 150 (i.e., after the composite material 28 has been applied), as illustrated in FIG. 6. In this case, the release layer may be a third release layer 61 which is added across the composite material 28 and the top surface 76 of the elastomeric plug 60. This third release layer 61 may be utilized in addition to or instead of applying a first release layer 58 before step 150, as illustrated in FIG. 4. Note that the third release layer 61 illustrated in FIG. 6, which is applied atop the layer of composite material 28, may be a thin sheet of flexible plastic material suitable for use as a separator/release sheet and/or as a breather/bleeder sheet, which is disposed between the composite material 28 and any other layers (not shown) which may be subsequently applied, such as caul sheets and vacuum bagging films.

At block 160, the method 100 may further include an optional step of deflating the elastomeric plug 60, if the elastomeric plug 60 is an inflatable bladder 64 which was previously inflated. At block 170, the method 100 may further include removing the elastomeric plug 60 from the trough 56. In configurations where the top 76 of the plug 60 is not covered by composite material 28, such as shown in FIG. 6, the elastomeric plug 60 may be optionally deflated and lifted out from the trough 56 and removed therefrom. In other configurations where the top 76 of the plug 60 is covered by composite materials 28, such as shown in FIGS. 8 and 9, the optional step 160 of deflating the elastomeric plug 60 and step 170 of removing the elastomeric plug 60 may be performed after curing the composite part 22 (discussed in step 180 below), particularly if the elastomeric plug 60 is made of material which can withstand the heat, pressure and/or other conditions presented during the curing process.

At block 180, and as illustrated in FIGS. 6, 8 and 9, the method 100 may further include curing the composite part 22 by applying heat, electromagnetic radiation, pressure and/or vacuum 96. Electromagnetic radiation 96 may include infrared light, ultraviolet light, microwave radiation or any other form of radiation along the electromagnetic spectrum. Pressure or vacuum 96 may include the application of direct pressure or vacuum where cauls, vacuum bags and/or other media press against the outer surface of the composite part 22 under the influence of pressure or vacuum, and/or may include the indirect application of pressure where the atmospheric pressure surrounding the composite part 22 is increased without any media or objects disposed in contact with the outer surface of the composite part 22 (such as in a pressure chamber). The heat, electromagnetic radiation, pressure and/or vacuum 96 may be applied for an amount of time sufficient to cure the composite material 28 to a desired degree, so that the composite part 22 may then be removed from the tooling set 20.

FIG. 7 shows a schematic cross-sectional partially assembled view of the tooling set 20 in which an interference fit 94 may be provided between the elastomeric plug 60 and the sides 32, 42 of the first and second mandrels 30, 40. In this configuration, the elastomeric plug 60 may have one or more recesses 86 and one or more protrusions 88 formed near the bottom of the plug 60. These one or more recesses 86 and one or more protrusions 88 are configured such that an interference fit 94 is provided when the elastomeric plug 60 is inserted into and seated within the trough 56.

FIGS. 10A-C show various configurations of the first and second chamfers 36, 46 and their respective first and second chamfer profiles 38, 48. FIG. 10A shows an exemplary straight chamfer profile 80, which provides a first shaped portion 33 for the first chamfer 36 and a second shaped portion 43 for the second chamfer 46 which appear in cross-section as straight lines from a respective top corner 35, 45 to a respective bottom corner 37, 47. FIG. 10B shows an exemplary cove profile 82, which provides a first shaped portion 33 for the first chamfer 36 and a second shaped portion 43 for the second chamfer 46 which appear in cross-section as arcuate lines from a respective top corner 35, 45 to a respective bottom corner 37, 47. And FIG. 10C shows an exemplary ogee profile 84, which provides a first shaped portion 33 for the first chamfer 36 and a second shaped portion 43 for the second chamfer 46 which appear in cross-section as double-curved lines from a respective top corner 35, 45 to a respective bottom corner 37, 47. The top corners 35, 45 and bottom corners 37, 47 may be relatively sharp, as shown in FIGS. 10A-B, or they may be rounded as illustrated by the top corners 35, 45 in FIG. 10C. For each of the profiles 80, 82, 84 shown, when the first and second sides 32, 42 are abutted together, the first and second abuttable portions 31, 41 are brought together in contact to form a trough 56 having a cross-sectional trough profile 74 defined by the first and second chamfers 36, 46 and their respective chamfer profiles 38, 48. Other shapes and configurations for the chamfers 36, 46 and their respective profiles 38, 48 are possible besides those illustrated here.

In one or more embodiments disclosed herein, the method 100 of producing a composite part 22 using first and second mandrels 30, 40, wherein each of the mandrels 30, 40 has a respective side 32, 42, a respective generally planar tool surface 34, 44 for forming a respective portion 24, 26 of the composite part 22 thereon and a respective chamfer 36, 46 between the respective side 32, 42 and the respective tool surface 34, 44, comprises the steps of: (i) at block 110, disposing the first and second mandrels 30, 40 with their respective sides 32, 42 abutted with each other such that the tool surfaces 34, 44 are flush with each other and define a generally planar combined surface 50 and the chamfers 36, 46 define a trough 56; (ii) at block 130, placing an elastomeric plug 60 in the trough 56, wherein the elastomeric plug 60 substantially fills the trough 56; and (iii) at block 150, applying a layer of composite material 28 across the generally planar combined surface 50 and across a top surface 76 of the elastomeric plug 60 so as to form the composite part 22.

In one or more embodiments disclosed herein, the tooling set 20 for producing a composite part 22, comprises: (i) first and second mandrels 30, 40, wherein each of the mandrels 30, 40 has a respective side 32, 42, a respective generally planar tool surface 34, 44 for forming a respective portion 24, 26 of the composite part 22 thereon and a respective chamfer 36, 46 between the respective side 32, 42 and the respective tool surface 34, 44, the mandrels 30, 40 being configured such that when the mandrels 30, 40 are disposed with their respective sides 32, 42 abutted with each other the tool surfaces 34, 44 are disposed flush with each other and define a generally planar combined surface 50 and the chamfers 36, 46 define a trough 56; and (ii) an elastomeric plug 60 configured for insertion into the trough 56, thereby defining a plugged arrangement 62, wherein the elastomeric plug 60 substantially fills the trough 56.

The tooling set 20 and method 100 disclosed herein provide a practical solution to the aforementioned challenges which may arise from mismatches or misalignments between adjacently disposed mandrels 30, 40 in the production of composite parts 22. Further, the tooling set 20 and method 100 offer advantages that are not provided by previously known approaches. These advantages include improvements to the quality and assembly of component parts 22 which are produced using the tooling set 20 and method 100 disclosed herein.

The above description is intended to be illustrative, and not restrictive. While various specific embodiments have been presented, those skilled in the art will recognize that the disclosure can be practiced with various modifications within the spirit and scope of the claims. While the dimensions and types of materials described herein are intended to be illustrative, they are by no means limiting and are exemplary embodiments. Moreover, in the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, such as in the phrase “substantially circular” or “generally circular”, these adverbs mean “for the most part”, “to a significant extent” and/or “to a large degree”, and do not necessarily mean “perfectly”, “completely”, “strictly” or “entirely”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

1. A method of producing a composite part using first and second mandrels, wherein the composite part has a plurality of stringer portions and a skin portion, and wherein each of the mandrels has a respective first, side, a respective second side opposed to the respective generally planar tool surface between the respective first and second sides, a respective first chamfer between the respective first side and the respective tool surface, a respective second chamfer between the respective second side and the respective tool surface, and a respective stringer trough defined in the respective generally planar tool surface for forming a respective stringer portion of the composite part therein, comprising:
disposing the first and second mandrels with the first side of the first mandrel abutted with the second side of the second mandrel, such that the tool surfaces are flush with each other and define a generally planar combined surface for forming the skin portion of the composite part thereon and the first and second chamfers define a plug trough;
placing an elastomeric plug in the plug trough, wherein the elastomeric plug substantially fills the trough so as to preclude formation of any portion of the composite part within the plug trough; and
applying a layer of composite material across the generally planar combined surface and across a top surface of the elastomeric plug so as to form the composite part.

2. the method according to claim 1, further comprising: removing the elastomeric plug from the plug trough.

3. the method according to claim 2, wherein the elastomeric plug is an inflatable bladder, and further comprising:
deflating the elastomeric plug.

4. the method according to claim 1, wherein the top surface of the elastomeric plug is disposed outward from the generally planar combined surface.

5. the method according to claim 1, further comprising:
draping a first release layer across the respective generally planar tool surface.

6. the method according to claim 1, wherein the top surface of the elastomeric plug is disposed substantially flush with the generally planar combined surface.

7. the method according to claim 6, further comprising:
adding a second release layer across the generally planar combined surface and the top surface of the elastomeric plug.

8. the method according to claim 1, further comprising:
curing the composite part by applying at least one of heat, electromagnetic radiation, pressure and vacuum.

9. the method according to claim 1, wherein the generally planar combined surface is a flat surface or a curved surface.

10. the method according to claim 1, wherein an interference fit is provided between the elastomeric plug and the adjacent sides of the first and second mandrels.

11. A method of producing a composite part using first and second mandrels, wherein the composite part has a plurality of stringer portions and a skin portion, and wherein each of the mandrels has a respective first side, a respective second side opposed to the respective first side, a respective generally planar tool surface between the respective first and second sides a respective first chamfer between the respective first side and the respective tool surface, a respective second chamfer between the respective second side and the respective tool surface, and a respective stringer trough defined in the respective generally planar tool surface for forming a respective stringer portion of the composite part therein, comprising:
disposing the first and second mandrels with the first side of the first mandrel abutted with the second side of the second mandrel, such that the tool surfaces are flush with each other and define a generally planar combined surface for forming the skin portion of the composite part thereon and the first and second chamfers define a plug trough;
placing an elastomeric plug in the plug trough, wherein the elastomeric plug substantially fills the trough so as to preclude formation of any portion of the composite part within the plug trough;
applying a layer of composite material across the generally planar combined surface and across a top surface of the elastomeric plug so as to form the composite part;
removing the elastomeric plug from the plug trough; and
curing the composite part by applying at least one of heat, electromagnetic radiation, pressure and vacuum.

12. the method according to claim 11, wherein the elastomeric plug is an inflatable bladder, and further comprising:
deflating the elastomeric plug.

13. A tooling set for producing a composite part, wherein the composite part has a plurality of stringer portions and a skin portion, comprising:
first and second mandrels, wherein each of the mandrels has a respective first side, a respective second, side opposed to the respective first side, a respective generally planar tool surface between the respective first and second sides, a respective first chamfer between the respective first side and the respective tool surface, a respective second chamfer between the respective second side and the respective tool surface, and a respective stringer trough defined in the respective generally planar tool surface for forming a respective stringer portion of the composite part therein, the mandrels being configured such that when they are disposed with the first side of the first mandrel abutted with the second side of the second mandrel, the tool surfaces are disposed flush with each other and define a generally planar combined surface for forming the skin portion of the composite part thereon and the first and second chamfers define a plug trough; and
an elastomeric plug configured for insertion into the plug trough, thereby defining a plugged arrangement, wherein the elastomeric plug is configured to substantially fill the plug trough so as to preclude formation of any portion of the composite past within the plug trough.

14. the tooling set according to claim 13, wherein the elastomeric plug is an inflatable bladder.

15. the tooling set according to claim 13, wherein the elastomeric plug is shaped as an extrusion having a cross-sectional profile substantially similar to a cross-sectional shape of the plug trough.

16. the tooling set according to claim 13, wherein each chamfer has a respective profile shaped as a straight chamfer profile, a cove profile or an ogee profile.

17. the tooling set according to claim 13, wherein the generally planar combined surface is a flat surface or a curved surface.

18. the tooling set according to claim 13, wherein a top surface of the elastomeric plug generally conforms in shape with the generally planar combined surface.

19. the tooling set according to claim 13, wherein, in the plugged arrangement, the top surface of the elastomeric plug is disposed substantially flush with or generally outward from the generally planar combined surface.

20. the tooling set according to claim 13, wherein, in the plugged arrangement, an interference fit is provided between the elastomeric plug and the adjacent sides of the first and second mandrels.
